(19) United States
(12) Patent Application Publication
(10) Pub. No.: US 2012/0018910 A1
(43) Pub. Date: Jan. 26, 2012

(54) Apparatus to add gas from liquid state source to a dry carrier gas at low pressure

(76) Inventors: Gil G. Moreno, Tampa, FL (US); Gil Moreno, Tampa, FL (US)

(21) Appl. No.: 12/804,592

(22) Filed: Jul. 26, 2010

(51) Int. Cl. B01F 3/04

(52) U.S. Cl. 261/122.1; 261/61

(57) ABSTRACT

This relates to an apparatus to add gas from liquid state source to a dry carrier gas at low pressure and delivery method.

### BACKGROUND OF THE INVENTION

Our patent application Ser. No. 12/590,272 requires an apparatus to add gas from liquid state source to a dry carrier gas at low pressure operation with small spout with removable plug to unload and reload the application liquid. U.S. Pat. No. 2,902,269 does not have small spout with removable plug to load and unload the application liquid and requires the removal of the unit cap for reloading. U.S. Pat. No. 6,202,991 requires a pressure relief valve. The present Invention solves said problems economically.

### SUMMARY OF THE INVENTION

The principal object of the present invention is to provide a device to add gas from liquid state source to a dry carrier gas at low pressure that is portable and requires minimum mental effort to operate.

It is also an object of the present invention to provide a device, which is of inexpensive construction.

Another object of the present invention is to provide a device that is attractive and pleasant to use.

A further object is to provide a device that will contribute to a healthy life.

### BRIEF DESCRIPTION OF THE DRAWINGS

FIG. 1 is an elevation view of the apparatus to add gas from liquid state source to a dry carrier gas at low pressure.

FIG. 2 is a top view of the apparatus to add gas from liquid state source to a dry carrier gas at low pressure.

FIG. 3 is a sectional view of the nozzle to deliver a mixture of gas from liquid state source and a dry carrier gas at low pressure.

### DESCRIPTION OF THE PREFERRED EMBODIMENTS.

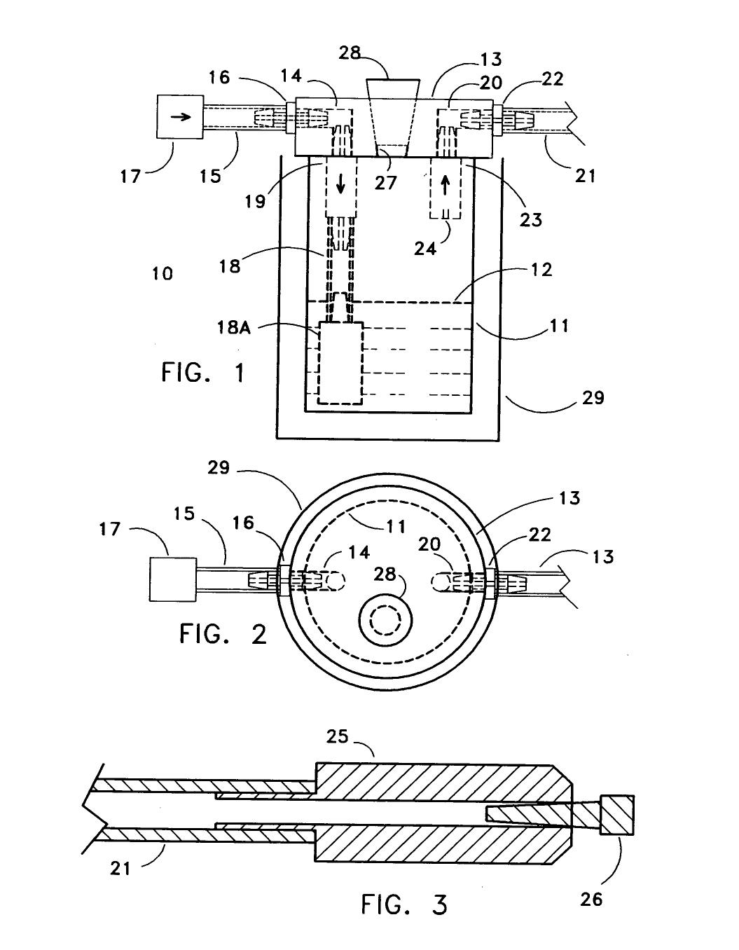

Referring to FIG. 1-FIG. 3 the device generally designated 10 comprises a container 11 made of transparent material with a mark 12 to indicate the filling level of liquid state source. Said 11 has a leak proof manifold lid 13 with inlet bore 14. Said 14 is a 90 degree internal elbow of circular cross section. The first leg of said 14 accepts 11 external supply hose 15 via a barbed tube fitting 16. Said 15 is connected to dry carrier gas supply at low pressure 17. Said 17 can be an electric air pump or a manual bulb air pump. The second leg of said 14 accepts 11 internal supply tubular member 18 via normally closed valve 19 that opens under pressure of said dry carrier gas. Said 18 accepts air diffuser 18A which ends near the bottom of said 11. 18A is similar to the air diffusing stone used in aquariums and can be omitted without great effect. Said 13 has exit bore 20 which is a 90 degree internal elbow of circular cross section. The first leg of 20 accepts 11 external delivery hose 21 via barbed tube fitting 22. Said 21 terminate in delivery nozzle 25 with plug 26. The second leg of said 20 terminates inside said 11 and has normally open valve 23 that closes when rotates in a vertical axial plane between 90 and 180 degrees. 24 is the admission of said 23. Said 13 has a conical hole 27 of mean diameter smaller than said 13 diameter to receive a conical plug 28 fitting leak proof. Said 27 is used to load and unload said 11. Said 27 and 28 may be replaced by small pop off lid and receptacle of diameter smaller than the diameter of said 13. Said 27 and 28 also may be replaced by a threaded cap and receptacle of diameter relatively smaller than the diameter of said 13. Light shield 29 is made of opaque material and surrounds said 11 during storage.

Although the invention has been disclosed in its prefer forms with a certain degree of particularity, it is understood that the invention of the preferred forms has been made by way of examples, that numerous changes in the detail of construction and the combination and arrangement of parts may be resorted to without departing from the spirit and scope of the invention.

What is claimed is:

1. An Apparatus to add gas from liquid state source to a dry carrier gas at low pressure comprising in combination:
a container for low pressure operation;
a container for low pressure operation manifold lid;
an external supply hose;
an internal admission one way valve normally closed;
an internal supply tubular member terminated with an air diffuser stone;
an internal delivery one way valve normally open;
an external delivery hose with nozzle and plug;
a container for low pressure operation light shield.

2. An apparatus as set forth in claim 1 wherein said container for low pressure operation is made of transparent material and has a mark to indicate the maximum liquid level.

3. An apparatus as set forth in claim 1 wherein said container manifold lid for low pressure operation fits leak proof said container for low pressure operation.

4. An apparatus as set forth in claim 1 wherein said container for low pressure operation manifold lid has a conical hole to accept leak proof a conical plug to load and unload said container for low pressure operation.

5. An apparatus as set forth in claim 1 wherein said container manifold lid has a first 90 degree internal elbow conduit of circular cross section with one leg oriented to accept said external supply hose via barbed tube fitting and the other leg oriented to accept said internal supply one way valve normally closed with internal supply tubular member terminated with and air diffuser stone.

6. An apparatus as set forth in claim 1 wherein said container manifold lid has a second 90 degree internal elbow conduit of circular cross section with one leg oriented to accept said internal delivery one way valve normally open that closes when rotates between 90 and 180 degrees in a vertical axial plane and the other leg oriented to accept said external delivery hose with nozzle and plug via barbed tube fitting.

7. An apparatus as set forth in claim 1 wherein said container for low pressure operation has a shield to prevent penetration of light.
